(19) United States
(12) Patent Application Publication
(10) Pub. No.: US 2015/0161551 A1
(43) Pub. Date: Jun. 11, 2015

(54) MANAGEMENT OF MULTI-SITE DASHBOARDS

(71) Applicant: Vivint, Inc., Provo, UT (US)

(72) Inventors: Jeremy Bruce Warren, Draper, UT (US); Matthew J. Eyring, Provo, UT (US); James Ellis Nye, Alpine, UT (US); Jungtaik Hwang, Draper, UT (US)

(21) Appl. No.: 14/561,621

(22) Filed: Dec. 5, 2014

Related U.S. Application Data
(60) Provisional application No. 61/912,936, filed on Dec. 6, 2013.

(51) Int. Cl. G06Q 10/06

(52) U.S. Cl. CPC G06Q 10/06395

(57) ABSTRACT

A computer-implemented method for multi-site dashboards is described. In one embodiment, an activity of a commercial entity is monitored, via a sensor at a first location, in relation to a policy associated with the commercial entity. Whether a value derived from the monitored activity satisfies a predetermined threshold of the policy is determined. Upon determining the value derived from the monitored activity satisfies the predetermined threshold of the policy, a notification is generated. The notification includes information related to the value derived from the monitored activity.

### CROSS REFERENCE

This application claims priority from co-pending U.S. Provisional Patent Application No. 61/912,936 entitled “MANAGEMENT OF MULTI-SITE DASHBOARDS,” which was filed 6 Dec. 2013, and assigned to the assignee hereof.

### BACKGROUND

Advancements in media delivery systems and media-related technologies continue to increase at a rapid pace. Increasing demand for media has influenced the advances made to media-related technologies. Computer systems have increasingly become an integral part of the media-related technologies. Computer systems may be used to carry out several media-related functions. The wide-spread access to media has been accelerated by the increased use of computer networks, including the Internet and cloud networking.

Many homes and businesses use one or more computer networks to generate, deliver, and receive data and information between the various computers connected to computer networks. Users of computer technologies continue to demand increased access to information and an increase in the efficiency of these technologies. Improving the efficiency of computer technologies is desirable to those who use and rely on computers.

With the wide-spread use of computers and mobile devices has come an increased presence of home automation and security products. Advancements in mobile devices allow users to monitor an aspect of a home or business. Information related to one location, however, may not be readily available at another location.

### SUMMARY

According to at least one embodiment, a computer-implemented method for multi-site dashboards is described. In one embodiment, an activity of a commercial entity may be monitored, via a sensor at a first location, in relation to a policy associated with the commercial entity. Whether a value derived from the monitored activity satisfies a predetermined threshold of the policy may be determined. Upon determining the value derived from the monitored activity satisfies the predetermined threshold of the policy, a notification may be generated. The notification may include information related to the value derived from the monitored activity.

In some embodiments, according to the information related to the value derived from the monitored activity, an off-site indicator panel located at a second location may be updated. The second location may be different from the first location. A location of a user associated with the commercial entity may be determined. Upon determining the user is not located at the second location, an electronic message may be sent that is addressed to the user. The electronic message may include the information related to the value derived from the monitored activity. According to the information related to the value derived from the monitored activity, an on-site indicator panel located at the first location may be updated.

Upon determining a user associated with the commercial entity is watching subscription programming on a display, the notification may be shown on the display. A live feed of the first location may be shown on the display in conjunction with the notification. Upon determining a display is deactivated, the display may be activated and the notification shown on the activated display. The activity being monitored may include counting a number of customers at the first location, capturing an image of a customer via the sensor, and identifying the customer via performance of a customer recognition algorithm in relation to the image of the customer. The activity being monitored may include tracking a location of an employee and/or an aspect of a product or service associated with the commercial entity. The aspect of the product or service may include at least one of a number of customers served, a location of a customer, customer satisfaction, a number of sales, a number of contacts, a number of products produced, a number of products served, a number of products received, a number of products delivered, a location of a product, and revenue generated.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a block diagram illustrating one example of a dashboard module;

FIG. 3 is a block diagram illustrating one example of an environment for multi-site dashboards configured to improve access to information related to commercial activities;

FIG. 4 is a block diagram illustrating one example of a multi-site dashboard displaying information related to the monitoring of commercial activities;

FIG. 5 is a block diagram illustrating another example of a multi-site dashboard displaying information related to the monitoring of commercial activities;

FIG. 6 is a flow diagram illustrating one embodiment of a method for monitoring activities related to a commercial entity;

FIG. 7 is a flow diagram illustrating one embodiment of a method for updating one or more indicator panels according to monitored commercial activity;

FIG. 8 is a flow diagram illustrating one embodiment of a method for displaying a notification related to monitored activities of a commercial entity; and

FIG. 9 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods described herein relate to monitoring commercial activity. More specifically, the systems and methods described herein relate to receiving notifications, updates, warnings, alerts, etc., related to monitored aspects of a commercial place of business on an information panel (e.g., multi-site dashboards). Some embodiments of the systems and methods described herein relate to multi-site dashboards in relation to an integration of home automation and a subscriber-based media content set top box, such as a satellite and/or cable digital video recorder (DVR).

In one example, a user may desire to receive an alert in association with monitoring certain activities associated with a commercial place of business. For example, a manager of a manufacturing plant may want to know when an anomaly in production is detected. Presently, the manager may manually check production to detect anomalies. The present systems and methods provide the means for monitoring one or more aspects of a place of business and informing a user associated with the place of business of current conditions and anomalies associated with the monitored activities. Moreover, the systems and methods described herein may provide multiple dashboards at multiple sites to receive and display notifications in relation to the monitored aspects of the business. Furthermore, the systems and methods described herein may provide multi-site dashboards and notifications in relation to a channel of a subscriber-based media content set top box.

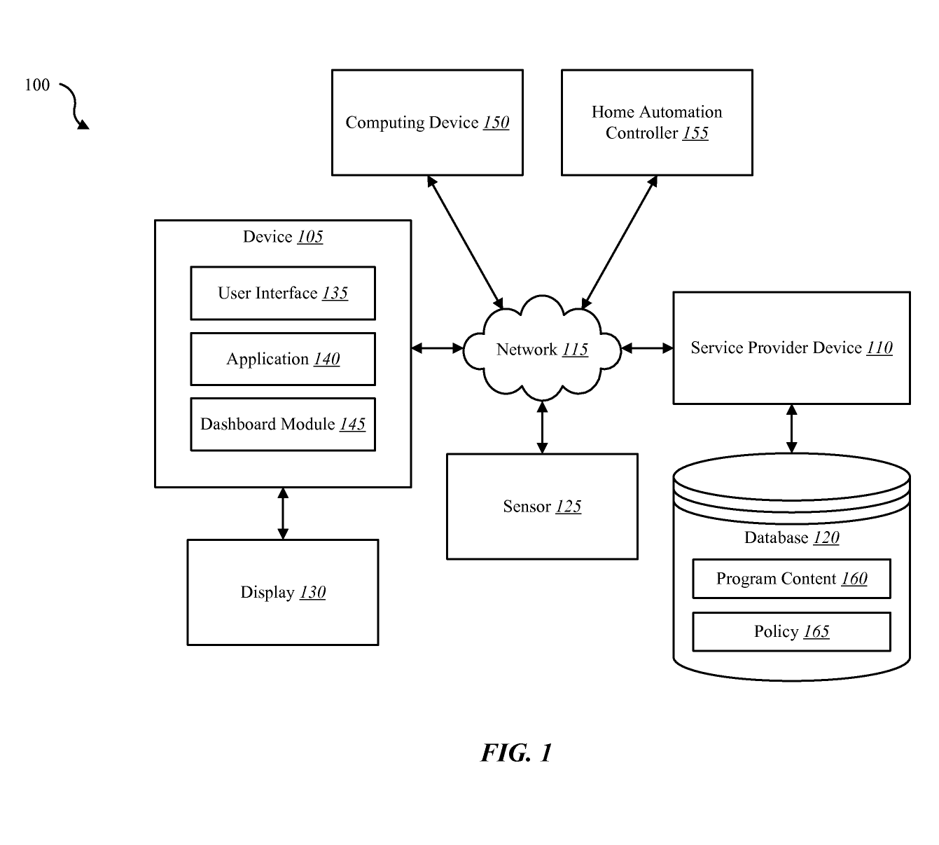

FIG. 1 is a block diagram illustrating one embodiment of an environment 100 in which the present systems and methods may be implemented. In some embodiments, the systems and methods described herein may be performed on a device (e.g., device 105). The environment 100 may include a device 105, service provider device 110, a sensor 125, a display 130, a computing device 150, a home automation controller 155, and a network 115 that allows the device 105, the service provider device 110, the computing device 150, home automation controller 155, and sensor 125 to communicate with one another. Examples of device 105 include control panels, indicator panels, multi-site dashboards, mobile devices, smart phones, personal computing devices, computers, servers, etc. Examples of the home automation controller 155 include a dedicated home automation computing device (e.g., wall-mounted controller), a personal computing device (e.g., laptop, desktop, etc.), a mobile computing device (e.g., tablet computing device, smartphone, etc.), and the like.

In some embodiments, device 105 may be integrated with home automation controller 155 in the form of one or more home automation controllers (e.g., handheld and/or wall-mounted controller) to both control aspects of a home and/or office as well as to receive and display notifications regarding monitored activity of a commercial entity (i.e., multi-site dashboard). Examples of sensor 125 include a camera sensor, audio sensor, forced entry sensor, shock sensor, proximity sensor, boundary sensor, appliance sensor, light fixture sensor, temperature sensor, light beam sensor, three-dimensional (3-D) sensor, motion sensor, smoke sensor, glass break sensor, door sensor, window sensor, carbon monoxide sensor, accelerometer, global positioning system (GPS) sensor, Wi-Fi positioning system sensor, capacitance sensor, radio frequency sensor, near-field sensor, heartbeat sensor, breathing sensor, oxygen sensor, carbon dioxide sensor, brain wave sensor, movement sensor, voice sensor, and the like.

Sensor 125 may represent one or more separate sensors or a combination of two or more sensors in a single device. For example, sensor 125 may represent one or more camera sensors and one or more motion sensors connected to environment 100. Additionally, or alternatively, sensor 125 may represent a combination sensor such as both a camera sensor and a motion sensor integrated in the same device. Sensor 125 may be integrated with a user recognition system. For example, sensor 125 may perform or connect to a device that performs facial recognition, voice recognition, gait recognition, and other computer-recognizable patterns by performing one or more recognition algorithms that identify an object, a user, etc. Although sensor 125 is depicted as connecting to device 105 over network 115, in some embodiments, sensor 125 may connect directly to device 105. Additionally, or alternatively, sensor 125 may be integrated with a home appliance or fixture such as a light bulb fixture. Sensor 125 may include an accelerometer to enable sensor 125 to detect a movement. Sensor 125 may include a wireless communication device enabling sensor 125 to send and receive data and/or information to and from one or more devices in environment 100. Additionally, or alternatively, sensor 125 may include a GPS sensor to enable sensor 125 to track a location of sensor 125. Sensor 125 may include a proximity sensor to enable sensor to detect proximity of a person relative to a predetermined distance from a dwelling (e.g., geo-fencing).

In some configurations, device 105 may include user interface 135, application 140, and dashboard module 145. Although the components of device 105 are depicted as being internal to device 105, it is understood that one or more of the components may be external to the device 105 and connect to device 105 through wired and/or wireless connections. For example, one or more components (e.g., software, firmware, and/or hardware) of dashboard module 145 may be located, installed, and/or part of home automation controller 155, computing device 150, service provider device 110, sensor 125, and/or database 120.

In some embodiments, computing device 150 may include a television set. Additionally, or alternatively, computing device 150 may include one or more processors, one or more memory devices, and/or a storage device. Examples of computing device 150 may include a viewing device associated with a media content set top box, satellite set top box, cable set top box, DVRs, personal video recorders (PVRs), and/or mobile computing devices, smart phones, personal computing devices, computers, servers, etc. Thus, application 140 may be installed on computing device 150 in order to allow a user to interface with a function of device 105, dashboard module 145, home automation controller 155, and/or service provider device 110.

In some embodiments, device 105 may communicate with service provider device 110 via network 115. Example of networks 115 include cloud networks, local area networks (LAN), wide area networks (WAN), virtual private networks (VPN), wireless networks (using 802.11, for example), and/or cellular networks (using 3G and/or LTE, for example), etc. In some configurations, the network 115 may include the internet. It is noted that in some embodiments, device 105 may not include a dashboard module 145. For example, device 105 may include application 140 that allows device 105 to interface with home automation controller 155 via dashboard module 145 located on another device such as computing device 150 and/or service provider device 110. In some embodiments, device 105, home automation controller 155, and service provider device 110 may include a dashboard module 145 where at least a portion of the functions of dashboard module 145 are performed separately, sequentially, and/or concurrently on device 105, home automation controller 155, and/or service provider device 110. Likewise, in some embodiments, a user may access the functions of device 105 and/or home automation controller 155 (directly or through device 105 via dashboard module 145) from computing device 150. For example, in some embodiments, computing device 150 includes a mobile application that interfaces with one or more functions of device 105, home automation controller 155, dashboard module 145, and/or service provider device 110.

In some embodiments, service provider device 110 may be coupled to database 120. Database 120 may include program content 160 and a policy 165 associated with the monitored activities of a commercial entity and/or place of business. For example, device 105 may access program content 160 in database 120 over network 115 via service provider device 110. Database 120 may be internal or external to the service provider device 110. In one example, device 105 may be coupled directly to database 120, database 120 being internal or external to device 105.

Dashboard module 145 may allow a user to control (either directly or via home automation controller 155) an aspect of the home or office of the user, including security, locking or unlocking a door, checking the status of a door, locating a person or item, controlling lighting, thermostat, cameras, receiving notification regarding a current status or anomaly associated with a home, office, place of business, and the like. In some embodiments, service provider device 110 may provide subscriber program content (cable/satellite/internet television programming, for example) to a user via a set top box, internet router, or other similar device located in a home, office, etc. Examples of set top boxes include cable set top boxes, satellite set top boxes, DVRs, PVRs, and the like. In some configurations, application 140 may enable device 105 to interface with home automation controller 155 via dashboard module 145 to provide home automation content to device 105 and/or computing device 150. Thus, application 140, via the dashboard module 145, may allow users to control aspects of their home and/or office. Further details regarding the dashboard module 145 are discussed below.

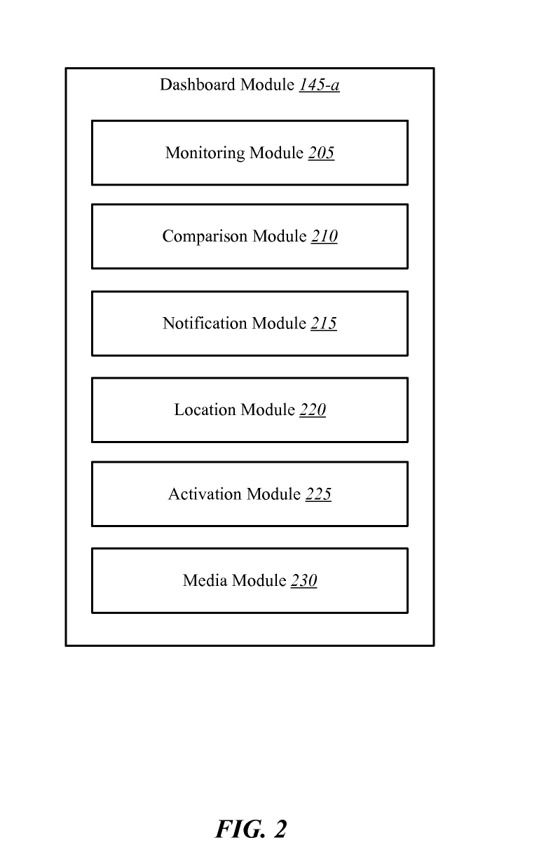

FIG. 2 is a block diagram illustrating one example of a dashboard module 145-a. Dashboard module 145-a may be one example of dashboard module 145 depicted in FIG. 1. As depicted, dashboard module 145-a may include monitoring module 205, comparison module 210, notification module 215, location module 220, activation module 225, and a media module 230.

Monitoring module 205 may be configured to monitor, via a sensor at a first location associated with a commercial entity, an activity of the commercial entity in relation to a policy (e.g., policy 165) associated with the commercial entity. For example, monitoring module 205 may monitor a status of an asset, product, service, vehicle, customer, employee, and any other aspect related to a commercial activity of a commercial entity and/or place of business. Monitoring module 205 may monitor a status of a commercial activity in conjunction with sensor 125. In some embodiments, monitoring module may capture an image of a customer via the sensor at the place of business. Monitoring module may identify the customer by performing a customer recognition algorithm in relation to the image of the customer (e.g., facial recognition algorithm, voice recognition, gait recognition, object recognition, and the like).

In some cases, monitoring module may monitor and/or track a time of arrival, a time of departure, current location, efficiency rating (e.g., number of products produced, number of tasks completed, number of customers served, etc.), and other similar aspects of an employee associated with the commercial entity. Upon determining one or more aspects of the employee satisfy a predetermined threshold, dashboard module 145-a may generate a notification. In some embodiments, monitoring module may track an aspect of a product or service associated with the commercial entity. The monitored aspect of the product or service may include at least one of a number of customers served, a location of a customer, a customer satisfaction, a number of sales made, a number of contacts made, a number of products produced, a number of products served, a number of products received, a number of products delivered, a location of a product, revenue generated, and other similar aspects of products or services of a place of business.

In one example, sensor 125 may detect a customer leaving from or arriving at a predefined area (e.g., a place of business). Upon detecting the customer arriving, monitoring module 205 may track the customer and/or one or more activities of the customer. In one example, monitoring module may count a number of customers at the place of business. Upon determining the detected number of customers satisfies a threshold predefined in policy 165, dashboard module 145-a may be triggered to perform an action such as generating a notification. For example, a monitored number of customers may be below a predefined threshold of customers, which may indicate a problem of which employees at the place of business may not be aware. By generating a notification and sending the notification to a person associated with the place of business, this person may survey the place of business focused on determining whether a problem exists and react to a potential problem in a timely manner, thus minimizing the likelihood that a potential problem may have an effect on the business.

In one embodiment, comparison module 210 may compare the monitored aspect of the place of business to a policy to determine whether a deviation exists between the monitored aspect of the place of business and a setting of the policy. Notification module 215 may send a notification to an occupant based on the determined deviation of the monitored aspect of the place of business. In one embodiment, notification module 215 may generate a notification in response to the monitoring of one or more aspects of the place of business and/or a detected anomaly associated with the one or more aspects of the place of business. In one example, dashboard module 145-a may generate a notification and/or play a sound to alert a user in relation to a monitored commercial activity. Additionally, or alternatively, dashboard module 145-a may detect anomalies in the commercial activities of a place of business, determine a cause of the anomalies, and provide notification regarding the detected anomalies.

In one embodiment, upon determining a value derived from the monitored activity satisfies a predetermined threshold of a policy, notification module may generate a notification. The notification may include information related to the value derived from the activity monitored at a first location (e.g., place of business). In one embodiment, in conjunction with notification module 215, dashboard module 145-a may display the information related to the value derived from the monitored activity, an off-site indicator panel located at a second location. In one example, an automated place of business may provide a product and/or service to a customer without the presence of an employee (e.g., vending machine, automatic teller machine, automatic movie rental machine, etc.). Thus, a user located apart from the place of business may be automatically alerted in real time to a potential problem without the person having to routinely inspect the place of business in person.

In some cases, the second location may be different from the first location, or place of business. For example, the second location may be on one floor of a building and the first location may be on a different floor of the same building. In one case, the first location may be at a first building of a building complex and the second location may be at a second building of the same building complex. Alternatively, the second location may be at a relatively distant geographic area from the first location such as on a different street, at a different address, a different city, etc. In one embodiment, in conjunction with notification module 215, dashboard module 145-a may display the information related to the value derived from the monitored activity on an on-site indicator panel located at the first location, or place of business.

In one embodiment, location module 220 may determine a location of a user associated with the commercial entity. For example, based on a setting of policy 165, dashboard module 145-a may determine that a particular user is to receive a notification related to a monitored activity of the place of business. In order to ensure that this user receives the notification, location module 220 may determine the user's location. For example, upon determining the user is not located at the second location, and thus away from the off-site indicator panel, notification module 215 may send an alternative notification in the form of an electronic message addressed to the user. This electronic message may include a version of the same information sent to the off-site indicator panel. In one embodiment, additionally or alternatively, upon determining a user associated with the commercial entity is watching subscription programming on a display, notification module 215 may display the notification on the display. In some cases, notification module 215 may display a live feed view of the first location on the display in conjunction with the notification. For example, notification module 215 may include a user-selectable link with the notification, the notification informing the user that clicking on the link activates a live feed view of the place of business (e.g., live video and/or live images). In some embodiments, upon determining a display is deactivated, activation module 225 may activate the display. For example, upon determining a particular user is located at the second location, but that a display (e.g., television, computer monitor, etc.) at the second location is deactivated, activation module 225 may activate the display. Upon determining the display is activated, notification module 215 may display the notification on the activated display.

In some embodiments, notification module 215, in conjunction with the user interface 135, may display a notification on a display connected to a set top box. Notification module 215 may display the notification in relation to a presently viewed channel of the subscriber program content. In some cases, notification module 215 may display the notification in at least a portion of a viewing area of the channel. For example, a user watching content from a satellite DVR on a television may receive a notification displayed on at least a portion of the screen of the television. For example, a notification relating to detecting a predefined action in relation to a set of golf clubs may be generated and sent to the user via email, text message, voicemail, etc. In relation to a set-top box service, the notification sent to the occupant may include a scrolling message, a picture-in-picture message, and/or switching to a notification or monitoring channel that includes data and/or information in relation to the detected activity.

In some embodiments, notification 215 may adapt a notification based on certain conditions. Notification module 215 may determine whether to display a notification on a display based on notification rules (e.g., type of program currently being viewed, type of activity detected, etc.) associated with a current state of device 105. For example, notification 215 may determine whether to display the notification the content provided by a set top box that a user is currently viewing. For instance, based on the notification rules, if the type of activity detected is determined to be a minor notification and if a user is watching sports (e.g., boxing match, baseball, football, etc.), notification 215 may alter the type of notification (e.g., scrolling message instead of picture-in-picture), block the message from being displayed on the television, and/or route the notification to another device, such as an email or a text message sent to a smartphone or tablet device. In some cases, notification module 215 may alter the notification based on the current state of the device 105. For one type of programming and set top box content, notification module 215 may show scrolling text across an edge of the television screen. For another type of programming, notification module 215 may play a sound (e.g., a tone, a combination of tones, a recorded voice notification, a text to speech notification, and the like) based on the type of notification. In some embodiments, notification module 215 may alter the destination of the notification based on the type of notification and/or the type of programming currently being viewed by the user. For example, if the notification rules require minimum notification for a certain type of programming, the notification module 215 may display in alternative modes of communication. For instance, notification module 215 may email or text message a notification to a user based on the type of notification, the type of programming the user is currently watching, whether programming is currently being watched, and/or the current location of the user, etc.

In some cases, notification 215 may determine whether to display a notification in relation to programming currently being watched by the user and how to handle the programming based on the type of notification and/or the type of programming. For example, dashboard module 145-a may pause the programming for one type of notification, show a pop up message for another type of notification without pausing the programming, split the screen between a window for a security camera view and a window for the programming for another type of notification, and so forth. Additionally, or alternatively, notification module 215 may pause the programming for one type of notification based on one type of programming, block the notification for the same type of notification based on another type of programming, and continue showing the programming for the same type of notification based on a third type of programming.

In some embodiments, upon detecting an aspect of a monitored commercial activity satisfies a predetermined threshold (e.g., a monitored aspect of the place of business indicating an anomaly), media module 230 may pause a subscriber program content currently provided on a channel. For example, the dashboard module 145-a may pause and/or record a portion of the content the user was viewing when the notification is displayed. In some cases, the notification may include a picture in picture notification, a text bar, scrolling text, a pop up, or drop down notification message. In some cases, the presently viewed channel may be paused upon the notification module 215 displaying the notification.

In one embodiment, media module 230 may provide subscriber program content to a user via a set top box located in a home of the user. Media module 230, in conjunction with the user interface 135, may provide a monitor channel to display the monitored commercial aspect of a place of business. The monitor channel may be displayed in a channel guide among channels of the subscriber program content. For example, a subscription to cable or satellite media content may include a channel guide that includes a list of selectable channels and their respective content. For instance, sensor 125 may provide one or more live video feeds of the place of business that are used as content for one or more of the channels. Among the list of channels provided by subscription, dashboard module 145-a may include one or more monitored commercial activity channels that are selectable and interact with user commands in a similar manner as the subscription channels in the channel guide (e.g., record, set timer, play, stop, rewind, fast forward, etc.).

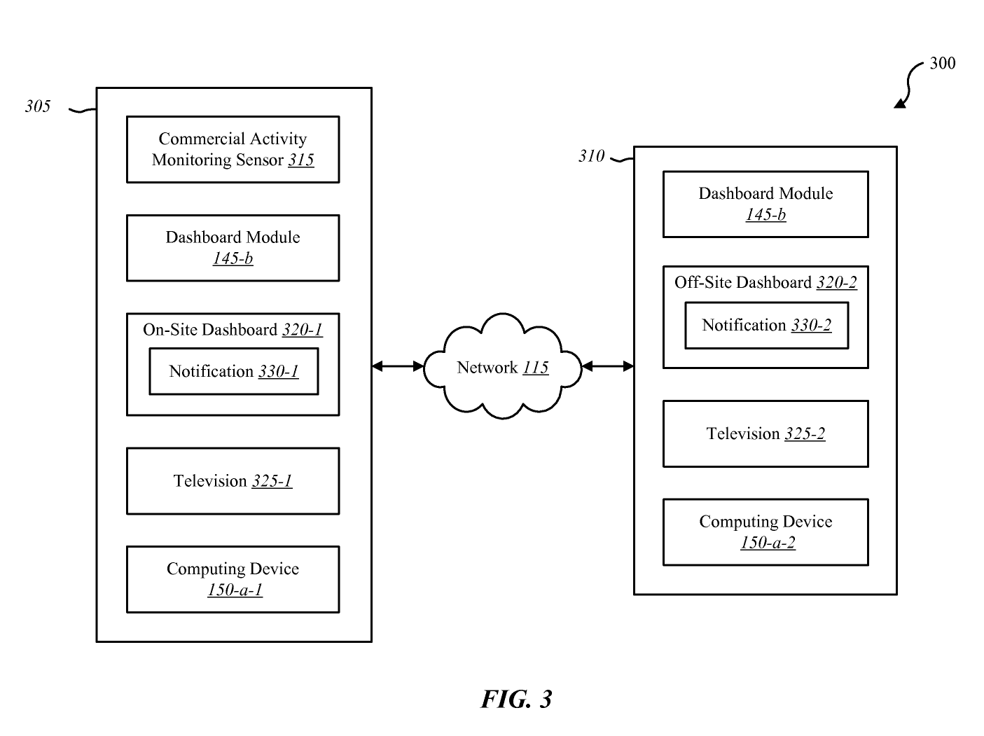

FIG. 3 is a block diagram illustrating one example of an environment 300 for multi-site dashboards configured to improve access to information related to commercial activities. As depicted, environment 300 may include an on-site location 305 and an off-site location 310. On-site location 305 may include a commercial activity monitoring sensor 315, dashboard module 145-b, on-site dashboard 320-1, television 325-1, and computing device 150-a-1. Off-site location 310 may include dashboard module 145-b, off-site dashboard 320-2, television 325-2, and computing device 150-a-2. Dashboards 320-1 and 320-2 may be configured to display notifications 330-1 and 330-2, respectively, in connection with monitored commercial activities at on-site location 305. Additionally, or alternatively, televisions 325-1 and 325-2 and/or computing devices 150-a-1 and 150-a-2 may be configured to show a similar notification. Dashboard module 145-b may be one example of dashboard module 145 of FIGS. 1 and/or 2. Sensor 315 may be one example of sensor 125 of FIG. 1.

In one embodiment, commercial activity monitoring sensor 315 may monitor one or more commercial activities occurring on-site location 305. Although a single sensor 315 is shown, it is understood that on-site location 305 may include one or more sensors. Dashboard module 145-b may compare monitored activities to one or more settings and/or thresholds of policy 165. Upon detecting an activity that satisfies a threshold of policy 165 (e.g., a current status and/or anomaly related to a monitored activity), dashboard module 145-b may generate a notification. Dashboard module 145-b may show the notification on one or more displays associated with on-site location 305, off-site location 310, and/or a device at a third location (e.g., a mobile computing located at a third location apart from both on-site location 305 and off-site location 310).

In one embodiment, on-site dashboard 320-1 may be located at a place of business where commercial activities are performed. Examples of places of business may include an automated place of business (e.g., automated vending machine, etc.), manufacturing plant, company office space, distribution plant, shipping company, restaurant, bakery, grocery store, clothing store, print shop, dry cleaners, automobile dealership, amusement park, and the like. Off-site dashboard 320-2 may be located at a location different than the place of business where the on-site dashboard 320-1 is located. In some embodiments, off-site dashboard 320-2 may be located in another area of the place of business. For example, on-site dashboard 320-1 may be located in a first room, floor, and/or building at a place of business and off-site dashboard 320-2 may be located in a second room, floor, and/or building at the same place of business. Alternatively, on-site dashboard 320-1 may be located at a place of business and off-site dashboard may be at a location apart from the place of business such as at an office or a residence on a different street, address, city, etc.

In one example, sensor 315 may detect an activity that satisfies a certain threshold. Upon identifying the anomaly, dashboard module 145-b may show a notification containing information regarding the anomaly on off-site dashboard 320-2. Additionally, or alternatively, dashboard module 145-b may show the notification on on-site dashboard 320-1. In some embodiments, dashboard module 145-b may detect that a person is watching television 325-1 at on-site location 305 and/or a person is watching television 325-2 at off-site location 310. Upon detecting one or both televisions being watched, dashboard module 145-b may show the notification on one or both televisions. Similarly, dashboard module 145-b may show the notification on computing device 150-a-1 and/or 150-a-2. Additionally, or alternatively, upon detecting a person associated with the commercial entity at on-site location 305 is neither located at on-site location 305 nor off-site location 310, but that this person is located at a third location, dashboard module 145-b may send a notification to a mobile computing device of this user at the third location. Thus, commercial activities being monitored at on-site location 305 may be relayed in real-time to one or more people at one or more locations in order to notify and keep these people aware of the monitored commercial activities, enabling the same people to be able to react to the information in a timely manner and avoid costly mistakes that may lead to loss of revenue, customer dissatisfaction, and the like.

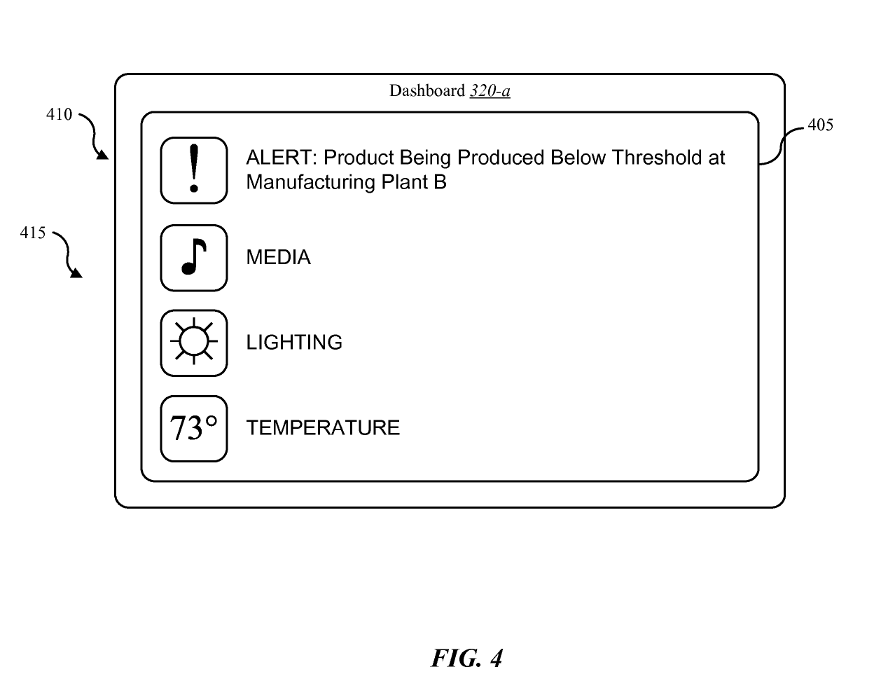

FIG. 4 is a block diagram illustrating one example of a multi-site dashboard 320-a displaying information related to the monitoring of commercial activities. As depicted, the dashboard 320-a (i.e., indicator panel) may include a display 405. Dashboard 320-a may be one example of device 105 of FIG. 1 and/or dashboard 320 of FIG. 2. In one embodiment, dashboard module 145 posts a visual notification 410 on display 405. Dashboard 320-a may include an audio speaker. Dashboard module 145 may play one or more audio tones on the audio speaker of dashboard 320-a to provide an auditory notification in conjunction with the visual notification 405 shown on display 405. The visual notification 405 may be shown on display 405 in conjunction with one or more home automation controls to allow a user to control media, lighting, temperature, for example.

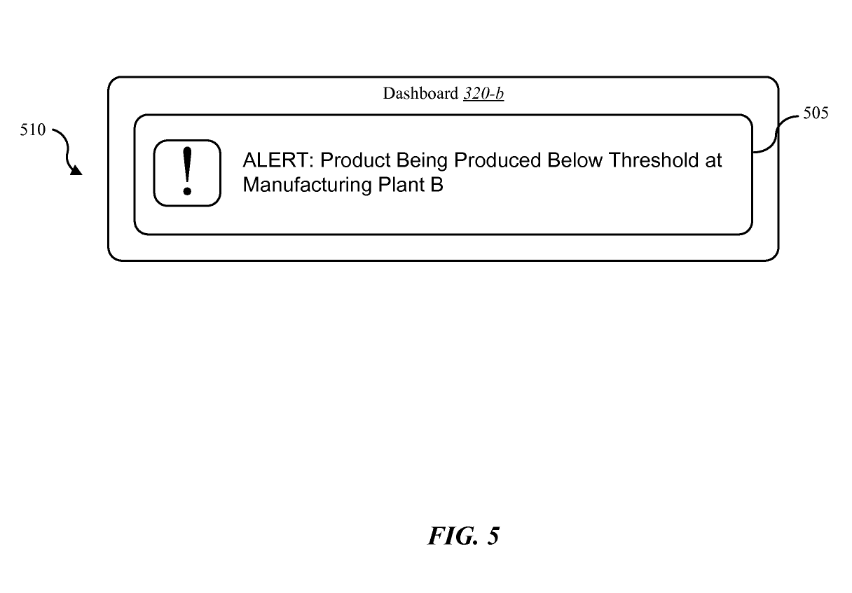

FIG. 5 is a block diagram illustrating another example of a multi-site dashboard 320-b displaying information related to the monitoring of commercial activities. As depicted, the dashboard 320-b (i.e., indicator panel) may include a display 505. Dashboard 320-a may be one example of device 105 of FIG. 1 and/or dashboard 320 of FIG. 2. In one embodiment, dashboard module 145 posts a visual notification 510 on display 505. Dashboard 320-b may include an audio speaker. Dashboard module 145 may play one or more audio tones on the audio speaker of dashboard 320-b to provide an auditory notification in conjunction with the visual notification 505 shown on display 505. In one embodiment, dashboard 320-b may include a viewing device dedicated to showing a current status, monitored activity, and/or detected anomaly associated with activities of a commercial entity and/or place of business.

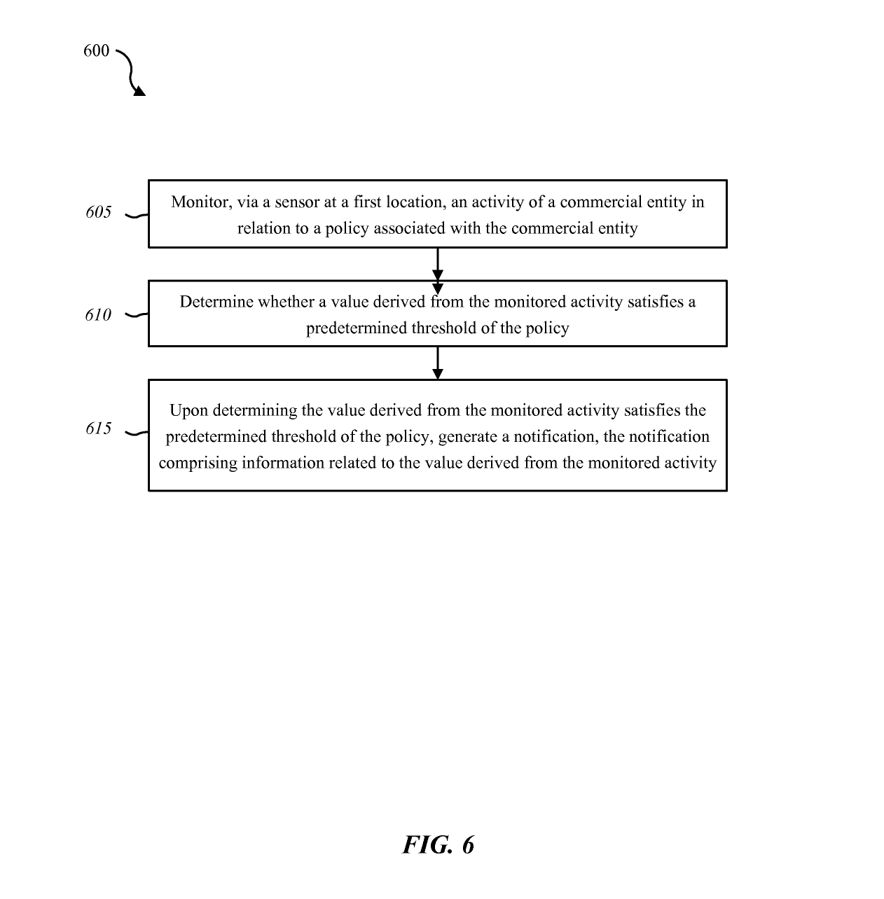

FIG. 6 is a flow diagram illustrating one embodiment of a method 600 for monitoring activities related to a commercial entity. In some configurations, the method 600 may be implemented by the dashboard module 145 illustrated in FIGS. 1, 2, and/or 3. In some configurations, the method 600 may be implemented in conjunction with the application 140 and/or the user interface 135 illustrated in FIG. 1.

At block 605, an activity of a commercial entity may be monitored, via a sensor at a first location, in relation to a policy associated with the commercial entity. At block 610, whether a value derived from the monitored activity satisfies a predetermined threshold of the policy may be determined. At block 615, upon determining the value derived from the monitored activity satisfies the predetermined threshold of the policy, a notification may be generated. The notification may include information related to the value derived from the monitored activity.

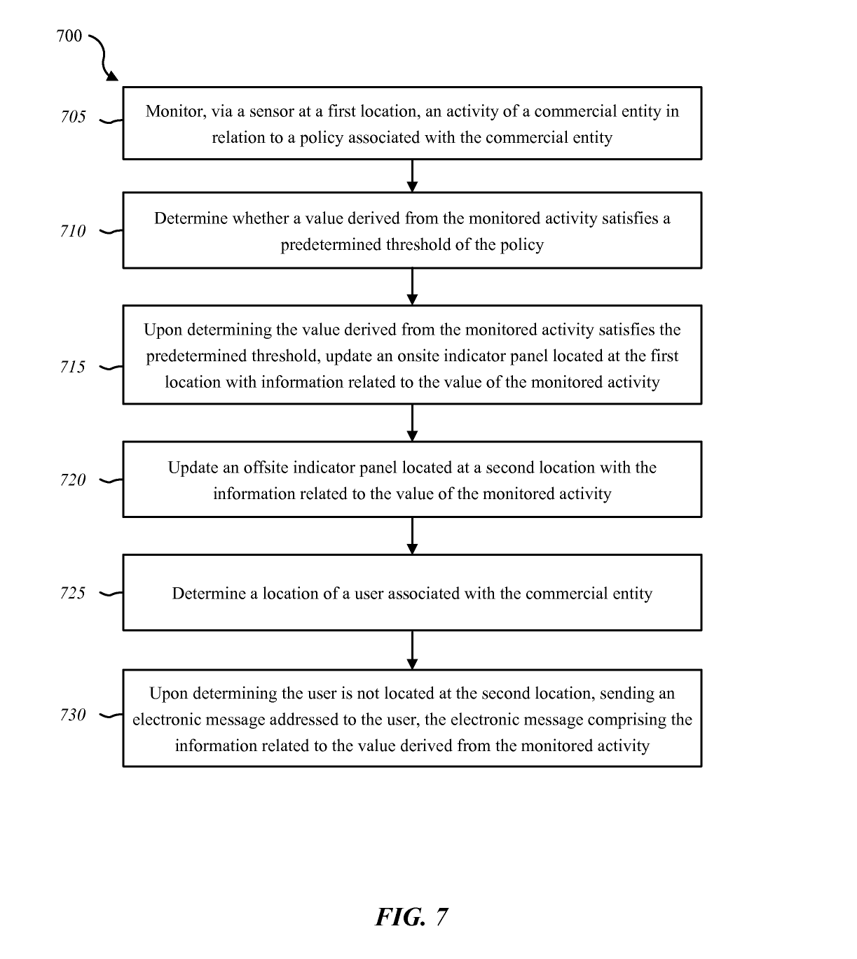

FIG. 7 is a flow diagram illustrating one embodiment of a method 700 for updating one or more indicator panels according to monitored commercial activity. In some configurations, the method 700 may be implemented by the dashboard module 145 illustrated in FIGS. 1, 2, and/or 3. In some configurations, the method 700 may be implemented in conjunction with the application 140 and/or the user interface 135 illustrated in FIG. 1.

At block 705, an activity of a commercial entity may be monitored, via a sensor at a first location, in relation to a policy associated with the commercial entity. At block 710, whether a value derived from the monitored activity satisfies a predetermined threshold of the policy may be determined. At block 715, upon determining the value derived from the monitored activity satisfies the predetermined threshold of the policy, an on-site indicator panel located at the first location may be updated with information related to the value of the monitored activity. At block 720, an off-site indicator panel located at a second location may be updated with the information related to the value of the monitored activity. The second location may be a location different from the first location. At block 725, a location of a user associated with the commercial entity may be determined. At block 730, upon determining the user is not located at the second location, an electronic message may be sent addressed to the user. The electronic message may include the information related to the value derived from the monitored activity.

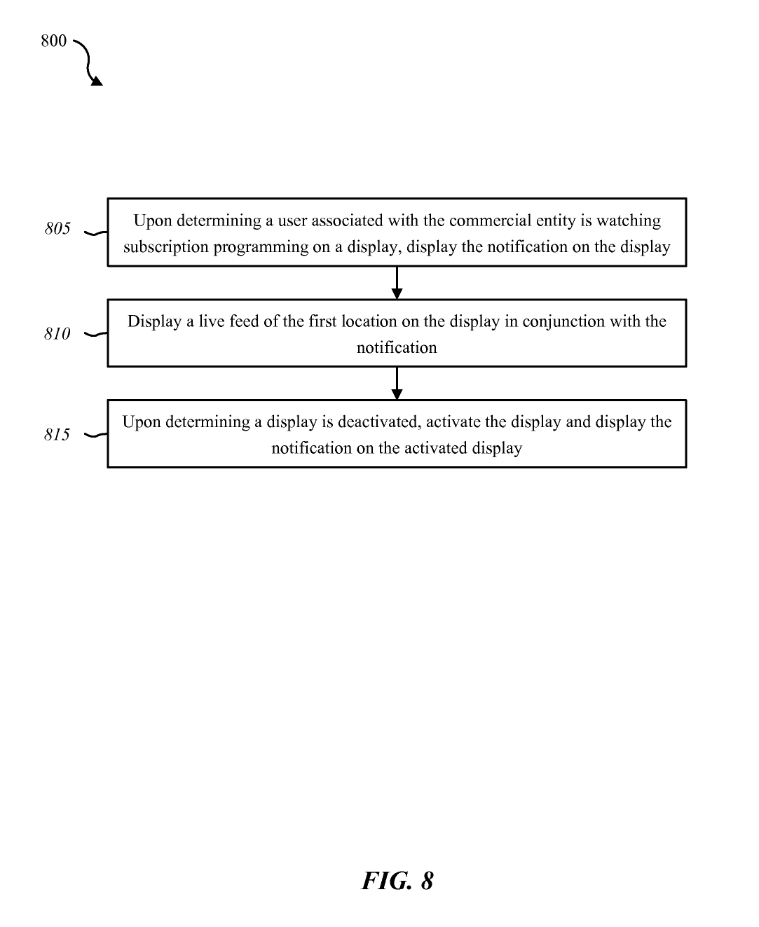

FIG. 8 is a flow diagram illustrating one embodiment of a method 800 for displaying a notification related to monitored activities of a commercial entity. In some configurations, the method 800 may be implemented by the dashboard module 145 illustrated in FIGS. 1, 2, and/or 3. In some configurations, the method 800 may be implemented in conjunction with the application 140 and/or the user interface 135 illustrated in FIG. 1.

At block 805, upon determining a user associated with the commercial entity is currently watching subscription programming on a display, the notification may be shown on the display. At block 810, a live feed of the first location may be shown on the display in conjunction with the notification. At block 815, upon determining a display is deactivated, the display may be activated and the notification may be shown on the activated display.

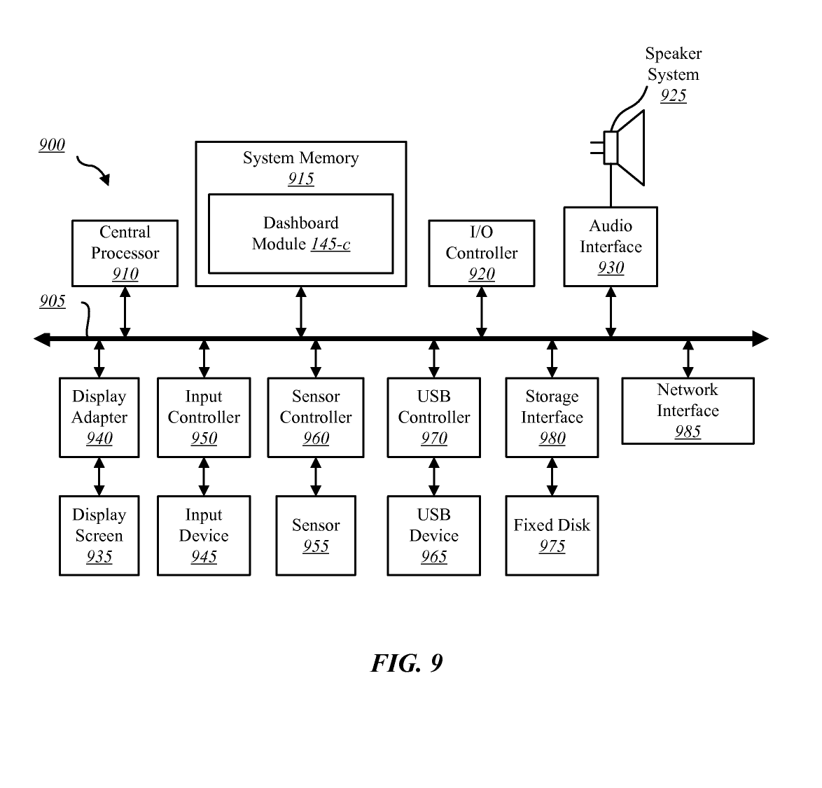

FIG. 9 depicts a block diagram of a controller 900 suitable for implementing the present systems and methods. The controller 900 may be an example of device 105, computing device 150, and/or home automation controller 155 illustrated in FIG. 1. In one configuration, controller 900 includes a bus 905 which interconnects major subsystems of controller 900, such as a central processor 915, a system memory 920 (typically RAM, but which may also include ROM, flash RAM, or the like), an input/output controller 925, an external audio device, such as a speaker system 930 via an audio output interface 935, an external device, such as a display screen 935 via display adapter 940, an input device 945 (e.g., remote control device interfaced with an input controller 950), multiple USB devices 965 (interfaced with a USB controller 970), and a storage interface 980. Also included are at least one sensor 955 connected to bus 905 through a sensor controller 960 and a network interface 985 (coupled directly to bus 905).

Bus 905 allows data communication between central processor 915 and system memory 920, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the dashboard module 145-b to implement the present systems and methods may be stored within the system memory 920. Applications (e.g., application 140) resident with controller 900 are generally stored on and accessed via a non-transitory computer readable medium, such as a hard disk drive (e.g., fixed disk 975) or other storage medium. Additionally, applications can be in the form of electronic signals modulated in accordance with the application and data communication technology when accessed via interface 985.

Storage interface 980, as with the other storage interfaces of controller 900, can connect to a standard computer readable medium for storage and/or retrieval of information, such as a fixed disk drive 975. Fixed disk drive 975 may be a part of controller 900 or may be separate and accessed through other interface systems. Network interface 985 may provide a direct connection to a remote server via a direct network link to the Internet via a POP (point of presence). Network interface 985 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to controller 900 wirelessly via network interface 985.

Many other devices or subsystems (not shown) may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 9 need not be present to practice the present systems and methods. The devices and subsystems can be interconnected in different ways from that shown in FIG. 9. The aspect of some operations of a system such as that shown in FIG. 9 are readily known in the art and are not discussed in detail in this application. Code to implement the present disclosure can be stored in a non-transitory computer-readable medium such as one or more of system memory 920 or fixed disk 975. The operating system provided on controller 900 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”In addition, the term “based on” as used in the specification and the claims is to be construed as meaning “based at least upon.”

What is claimed is:

1. A computer-implemented method for monitoring a commercial activity, the method comprising:
monitoring, via a sensor at a first location, an activity of a commercial entity in relation to a policy associated with the commercial entity;
determining whether a value derived from the monitored activity satisfies a predetermined threshold of the policy; and
upon determining the value derived from the monitored activity satisfies the predetermined threshold of the policy, generating a notification, the notification comprising information related to the value derived from the monitored activity.

2. The method of claim 1, further comprising:
displaying the information related to the value derived from the monitored activity on an off-site indicator panel located at a second location, the second location being different from the first location.

3. The method of claim 2, further comprising:
determining a location of a user associated with the commercial entity; and
upon determining the user is not located at the second location, sending an electronic message addressed to the user, the electronic message comprising the information related to the value derived from the monitored activity.

4. The method of claim 1, further comprising:
displaying the information related to the value derived from the monitored activity on an on-site indicator panel located at the first location.

5. The method of claim 1, further comprising:
upon determining a user associated with the commercial entity is watching subscription programming on a display, displaying the notification on the display.

6. The method of claim 5, further comprising:
displaying a live feed of the first location on the display in conjunction with the notification.

7. The method of claim 1, further comprising:
upon determining a display is deactivated, activating the display; and
displaying the notification on the display.

8. The method of claim 1, wherein the activity being monitored comprising:
counting a number of customers at the first location.

9. The method of claim 1, wherein the activity being monitored comprising:
capturing an image of a customer via the sensor;
identifying the customer via performance of a customer recognition algorithm in relation to the image of the customer.

10. The method of claim 1, wherein the activity being monitored comprising:
tracking a location of an employee associated with the commercial entity.

11. The method of claim 1, the activity being monitored comprising:
tracking an aspect of a product or service associated with the commercial entity, the aspect of the product or service comprising at least one of a number of customers served, a location of a customer, customer satisfaction, a number of sales, a number of contacts, a number of products produced, a number of products served, a number of products received, a number of products delivered, a location of a product, and revenue generated.

12. An apparatus for monitoring commercial activity, comprising:
a processor;
memory in electronic communication with the processor; and
instructions stored in the memory, the instructions being executable by the processor to:
monitor, via a sensor at a first location, an activity of a commercial entity in relation to a policy associated with the commercial entity;
determine whether a value derived from the monitored activity satisfies a predetermined threshold of the policy; and
upon determining the value derived from the monitored activity satisfies the predetermined threshold of the policy, generate a notification, the notification comprising information related to the value derived from the monitored activity.

13. The apparatus of claim 12, wherein the instructions are further executable by the processor to:
display the information related to the value derived from the monitored activity on an off-site indicator panel located at a second location, the second location being different from the first location.

14. The apparatus of claim 12, wherein the instructions are further executable by the processor to:
determine a location of a user associated with the commercial entity; and
upon determining the user is not located at the second location, send an electronic message addressed to the user, the electronic message comprising the information related to the value derived from the monitored activity.

15. The apparatus of claim 12, wherein the instructions are further executable by the processor to:
display the information related to the value derived from the monitored activity on an on-site indicator panel located at the first location.

16. The apparatus of claim 12, wherein the instructions are further executable by the processor to:
upon determining a user associated with the commercial entity is watching subscription programming on a display, display the notification on the display.

17. The apparatus of claim 12, wherein the instructions are further executable by the processor to:
displaying a live feed of the first location on the display in conjunction with the notification.

18. The apparatus of claim 12, wherein the instructions are further executable by the processor to:
upon determining a display is deactivated, activating the display; and
displaying the notification on the display.

19. The apparatus of claim 12, wherein the activity being monitored comprises:
capturing an image of a customer via the sensor; and
identifying the customer via performance of a customer recognition algorithm in relation to the image of the customer.

20. A non-transitory computer-readable medium storing computer-executable code for monitoring commercial activity, the code executable by a processor to:
monitor, via a sensor at a first location, an activity of a commercial entity in relation to a policy associated with the commercial entity;
determine whether a value derived from the monitored activity satisfies a predetermined threshold of the policy; and
upon determining the value derived from the monitored activity satisfies the predetermined threshold of the policy, generate a notification, the notification comprising information related to the value derived from the monitored activity.
